(19) United States
(12) Patent Application Publication
(10) Pub. No.: US 2006/0008245 A1
(43) Pub. Date: Jan. 12, 2006

(54) Image processing device and method

(75) Inventor: Seong-won Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/175,445

(22) Filed: Jul. 7, 2005

(30) Foreign Application Priority Data
Jul. 8, 2004 (KR) 2004-0053086

(51) Int. Cl. H04N 5/781

(52) U.S. Cl. 386/46; 386/126

(57) ABSTRACT

An image processing device and method which can restore a loss during compression and storage of a video frame. The image processing device includes a pattern detecting unit which detects a pattern of additional data included in a vertical blank interval (VBI) of a video frame, a video storing unit which stores the video frame, and a pattern restoring unit which restores the additional data based on the detected pattern when the stored video frame is reproduced.

### CROSS-REFERENCE TO RELATED APPLICATION

This application claims priority from Korean Patent Application No. 10-2004-0053086 filed on Jul. 8, 2004 in the Korean Intellectual Property Office, the disclosure of which is incorporated herein by reference.

### BACKGROUND OF THE INVENTION

1. Field of the Invention

The present invention relates to an image processing device and method, and more particularly, to an image processing device and method which can restore a loss caused during compression and storage of a video frame.

2. Description of Related Art

Digital video recorders (DVR) are generally used to monitor indoor and outdoor environments of buildings, underground parking lots, bank windows, or unmanned banking terminals.

DVRs store video/audio data in storage media such as hard disk drives or optical discs such as compact disc-recordables (CD-R), CD-rewritables (CD-RW), and digital versatile disc-recordables (DVD-R).

A DVR is connected to at least one camera and sensor that can acquire video data, and a user controls the operation of the camera and sensor using the DVR.

As shown in FIG. 1, a conventional image processing device includes a converting unit 10 that converts a video frame into a digital signal, a compressing unit 20 that compresses the converted video frame using a specified compression compressor/decompressor (codec), a video storing unit 30 that stores the compressed video frame, a reproducing unit 40 that extracts a video frame from the video storing unit 30 and reproduces the extracted video frame, and a decompressing unit 50 that decompresses the video frame extracted from the video storing unit 30 and transmits the decompressed video frame to the reproducing unit 40.

The converting unit 10 converts video frames transmitted from an additional data processing unit 70, which adds specified data to vertical blank interval (VBI) of video frames transmitted from a plurality of video acquiring units 61, 62, and 63, each of which acquires a video frame at a specified position.

The additional data processing unit 70 displays the frame transmitted from the reproducing unit 40 on a display unit 80.

The VBI is a portion of a video that is not displayed on the display unit 80. The VBI includes additional data such as caption information, time information, and information about a video acquiring unit that transmits a corresponding video frame.

To efficiently use the video storing unit 30 having a limited storage space, the compressing unit 20 compresses the converted video frame after removing from the converted video frame a high-frequency area that is difficult for a viewer to recognize.

At this time, when the converted video frame is compressed by the compressing unit 20, a high-frequency area of additional data included in a VBI of the converted video frame is also removed.

The reproducing unit 40 extracts a video frame to be reproduced from the video storing unit 30 and the decompressing unit 50 decompresses the extracted video frame and transmits the decompressed video frame to the reproducing unit 40.

The additional data processing unit 70 displays a video frame transmitted from the reproducing unit 40 on the display unit 80.

The conventional image processing device operates as follows.

Referring to FIGS. 1 and 2, a video frame acquired at a specified position is transmitted from each of the plurality of video acquiring units 61, 62, and 63 to the converting unit 10 through the additional data processing unit 70 in operation S11.

At this time, the additional data processing unit 70 transmits the video frame received from each of the plurality of video acquiring units 61, 62, and 63 to the converting unit 10 after adding additional data to a VBI of the received video frame.

The converting unit 10 converts the transmitted video frame into a digital signal in operation S12 and the compressing unit 20 compresses the converted video frame using a specified compression codec in operation S13.

The compressed video frame is stored in the video storing unit 30 in operation S14.

FIG. 3 is a flowchart illustrating a conventional method for reproducing a video frame stored in the video storing unit 30.

Referring to FIGS. 1 and 3, in operation S21, the reproducing unit 40 extracts a video frame to be reproduced from the video storing unit 30.

The extracted video frame is decompressed by the decompressing unit 50 in operation S22 and the reproducing unit 40 transmits the decompressed video frame to the additional data processing unit 70 in operation S23.

The additional data processing unit 70 displays the transmitted video frame in various ways according to additional data included in a VBI of the transmitted video frame in operation S24.

For example, the additional data processing unit 70 divides a screen of the display unit 80 into a number of sections corresponding to the number of video acquiring units that acquire video frames.

However, in the conventional image processing device and method, the compressing unit 20 compresses a video frame after removing a high-frequency area of the video frame for efficient use of the storage space of the video storing unit 30.

Thus, when a video frame stored in the video storing unit 30 is reproduced, the video frame transmitted from each of the plurality of video acquiring units 61, 62, and 63 is different from the video frame reproduced by the reproducing unit 40, since the high-frequency area is removed from the additional data.

Thus, when the additional data processing unit 70 displays the video frame transmitted from the reproducing unit 40 on the display unit 80, it is difficult for the display unit 80 to display the video frame using a proper display method due to loss of the additional data included in the VBI of the video frame.

Korean Patent Publication No. 1994-0010514 discloses a system for determining a malfunction of a frame memory by inserting a frame operation determining signal in a VBI of a video signal and detecting the frame operation determining signal of the video signal in a current frame and the frame operation determining signal of the video signal in an immediately previous frame. The system involves self-diagnosing the malfunction of the frame memory by detecting the frame operation determining signal of a video signal in a current frame and the frame operation determining signal of the video signal in an immediately previous frame, but does not suggest a method for restoring a loss caused by the malfunction of the frame memory.

### BRIEF SUMMARY

An aspect of the present invention provides an image processing device and method which can restore losses in additional data included in a VBI of a video frame by detecting a pattern of the additional data.

According to an aspect of the present invention, there is provided an image processing device including a pattern detecting unit, a video storing unit, and a pattern storing unit. The pattern detecting unit detects a pattern of additional data included in a vertical blank interval (VBI) of a video frame. The video storing unit stores the video frame. The pattern restoring unit restores the additional data based on the detected pattern when the stored video frame is reproduced.

According to another aspect of the present invention, there is provided an image processing method including detecting a pattern of additional data included in a vertical blank interval (VBI) of a specified video frame, storing the specified video frame, and restoring the additional data using the detected pattern when the stored video frame is reproduced.

According to another aspect of the present invention, there is provided an image processing method, including: adding additional information to a video frame; detecting a pattern of the additional data; compressing the video frame by removing a high frequency area of the additional data; and decompressing the compressed video frame and restoring the additional information using the detected pattern.

According to another aspect of the present invention, there is provided a method of increasing video frame storing efficiency, including: detecting a pattern of additional data included in a video frame, the pattern being usable to restore the additional data when the video frame is reproduced from a storage; compressing the video frame by removing a high frequency area of the additional data; and storing the video frame in the storage.

According to another aspect of the present invention, there is provided a method of increasing video frame reproducing efficiency, including: extracting a compressed stored video frame; and decompressing the extracted video frame and restoring lost additional data to the video frame using a detected pattern of the additional data, the detected pattern being detected in the video frame before compression of the video frame.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 illustrates a conventional image processing device;

FIG. 2 is a flowchart illustrating a conventional method for storing a video frame;

FIG. 3 is a flowchart illustrating a conventional method for reproducing a video frame stored in a video storing unit;

FIG. 4 illustrates an image processing device according to an embodiment of the present invention;

FIG. 5 is a flowchart illustrating a method for storing a video frame according to an embodiment of the present invention;

FIG. 6 illustrates a pattern of additional data usable in an apparatus and method according to an embodiment of the present invention;

FIG. 7 illustrates a pattern of additional data which additional data regarded as noise is removed;

FIG. 8 is a flowchart illustrating a method for reproducing a video frame stored in a video storing unit;

FIG. 9 illustrates a pattern of additional data of a decompressed video frame; and

FIG. 10 illustrates a pattern of additional data that is restored based on a detected pattern.

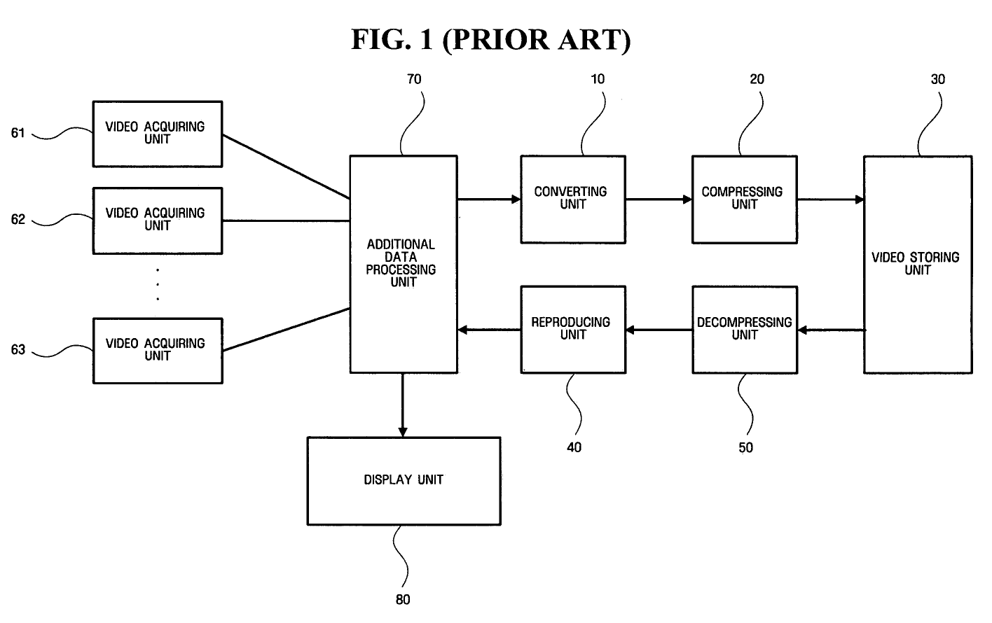

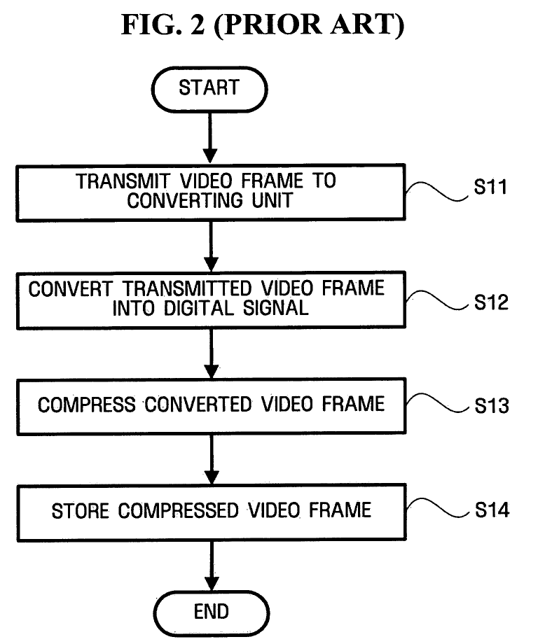

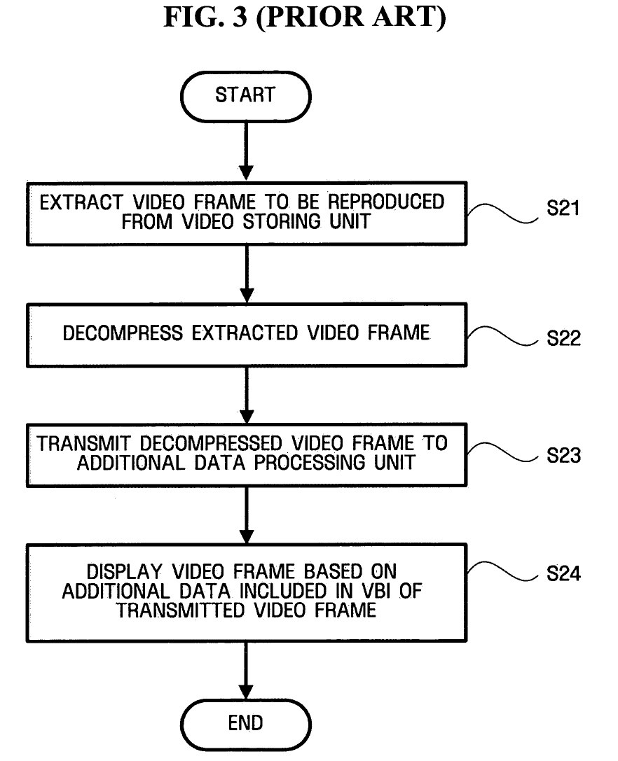

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

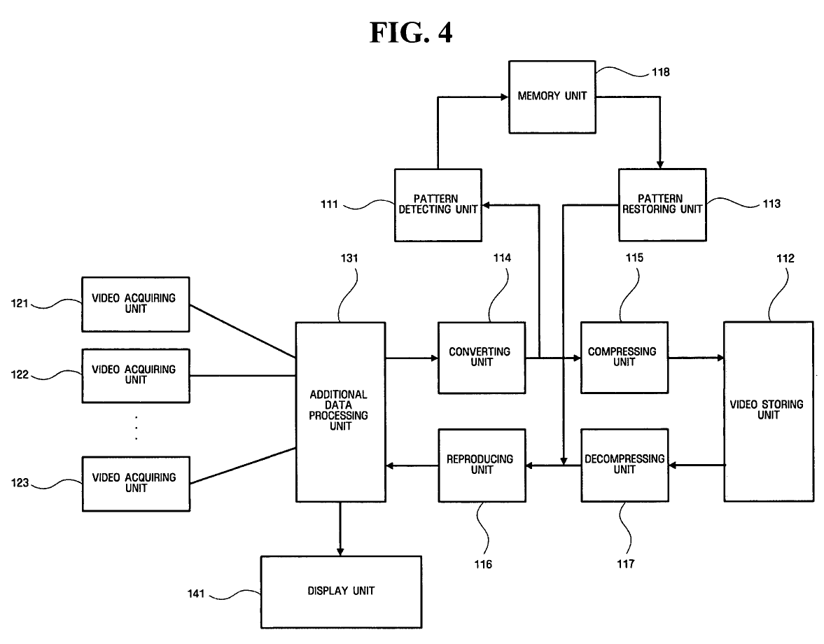

As shown in FIG. 4, an image processing device according to an embodiment of the present invention includes a pattern detecting unit 111 that detects a pattern of additional data included in a vertical blank interval (VBI) of a specified video frame, a video storing unit 112 that stores the video frame, and a pattern restoring unit 113 that restores additional data based on the detected pattern.

The image processing device also includes a converting unit 114 that converts a video frame to be stored in the video storing unit 112 into a digital signal, a compressing unit 115 that compresses the video frame converted into the digital signal using a specified compression codec, a reproducing unit 116 that extracts a video frame from the video storing unit 112 and reproduces the extracted video frame, a decompressing unit 117 that decompresses the compressed video frame, and a memory unit 118 that stores a pattern of additional data that is detected by the pattern detecting unit 111.

The video frame is acquired by each of a plurality of video acquiring units 121, 122, and 123, which are, by way of a non-limiting example, cameras, and the additional data processing unit 131 transmits the acquired video frame to the converting unit 114 after adding additional data to a VBI of the acquired video frame.

When video frames are simultaneously acquired from the plurality of video acquiring units 121, 122, and 123, the additional data processing unit 131 may add additional data such as, by way of a non-limiting example, information about the video acquiring units 121, 122, and 123 and time information to VBIs of the respective video frames.

The additional data processing unit 131 generally transmits the video frames to the converting unit 114. A speed of transmission can be 30 frames per second.

In this case, if the video frames are simultaneously transmitted from the plurality of video acquiring units 121, 122, and 123 to the additional data processing unit 131, they may be sequentially transmitted by the additional data processing unit 131 to the converting unit 114 in a specified order.

The additional data processing unit 131 adds to a VBI of the video frame additional data such as, by way of a non-limiting example, information about a video acquiring unit that transmits the video frame and time information about a time point at which the video frame is acquired.

The additional data processing unit 131 sends the video frames acquired by each of the plurality of video acquiring units 121, 122, and 123 and a video frame reproduced by the reproducing unit 116 to a display unit 141 for display thereon.

When the video frame stored in the video storing unit 112 is reproduced, if video frames are simultaneously acquired from the plurality of video acquiring units 121, 122, and 123, the additional data processing unit 131 may divide a screen of the display unit 141 into several sections and display the acquired video frames on the divided sections of the screen, respectively.

The pattern detecting unit 111 can detect a pattern of additional data included in a VBI of the video frame converted into a digital signal before the video frame is compressed by the compressing unit 115.

The pattern detecting unit 111 can detect a line of the VBI in which additional data exists and then detect a pattern of additional data that exist at specified intervals in the detected line.

Since lines with additional data may correspond to a number of pixels of the video frame, a section in which additional data exists and a specified interval between additional data may be distinguished from each other based on the number of pixels.

The pattern detecting unit 111 regards only additional data that exist at intervals of a specified number of pixels as an effective pattern of additional data and regards other additional data as noise and neglects such additional data. For example, when the intervals are 10 pixels, additional data that exist at intervals of 10 pixels are regarded as being valid and other additional data are regarded as noise and then neglected.

Since additional data added by an additional data processing unit exists at specified intervals, a video frame stored in the video storing unit 112 may only be displayed by the corresponding additional data processing unit.

Thus, when various additional data processing units are used, only a video frame to which additional data is added by an additional data processing unit can be displayed by the corresponding data processing unit.

To efficiently use the video storing unit 112, the compressing unit 115 may compress the video frame converted into a digital signal using a compression codec like JPEG or MPEG.

The compressing unit 115 may reduce a space of the video storing unit 112 occupied by the video frame by removing a high-frequency area that is difficult for a viewer to recognize.

As a result, a loss may also occur in additional data included in a VBI of a video frame stored in the video storing unit 112. The pattern restoring unit 113 may restore a loss in additional data when the video frame stored in the video storing unit 112 is reproduced.

At this time, the reproduction of the video frame stored in the video storing unit 112 may be made by extracting a video frame to be reproduced from the video storing unit 112, decompressing the video frame in the decompressing unit 117, and transmitting the decompressed video frame to the additional data processing unit 131.

The pattern restoring unit 113 can restore additional data lost from a VBI of the decompressed video frame using a pattern of additional data of an uncompressed video frame that is detected by the pattern detecting unit 111.

Thus, the additional data processing unit 131 can cause a video frame to be displayed on a specified display unit based on the restored additional data.

For example, when video frames are simultaneously acquired by a plurality of video acquiring units, the additional data processing unit 131 may divide a screen of the display unit 141 into a number of sections corresponding to the number of video acquiring units and display the video frames on the divided sections, respectively, based on additional data included in the video frames, such as information about the video acquiring units 121, 122, and 123 and time information about time points at which the video frames are acquired.

An operation of the image processing device according an embodiment of the present invention is as follows.

An image processing method according to an embodiment of the present invention may be divided into a method for storing a video frame acquired by each of a plurality of video acquiring units and a method for reproducing a video frame stored in the video storing unit. These methods can be performed by the apparatus of FIG. 4 and are, for ease of explanation only, described in conjunction with FIG. 4. However, it is to be understood that these methods can be performed by apparatuses of other configurations.

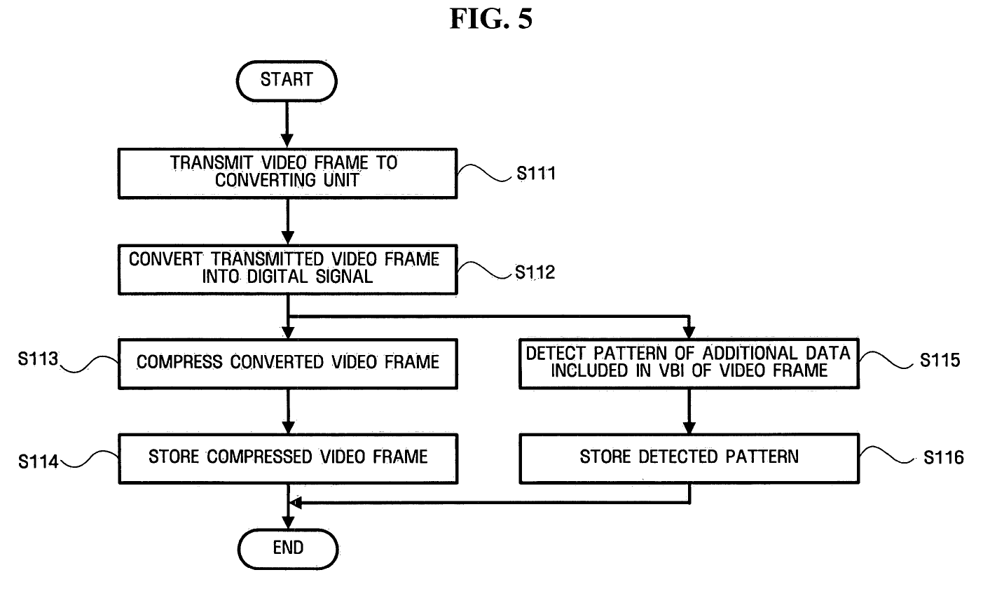

Referring to FIGS. 4 and 5, in a method for storing a video frame acquired by each of the plurality of video acquiring units 121, 122, and 123, the additional data processing unit 131 transmits a video frame acquired at a specified position from each of the plurality of video acquiring units 121, 122, and 123 to the converting unit 114 in operation S111.

At this time, additional information such as information about a video acquiring unit that acquires the video frame and time information about a time point at which the video frame is acquired may be added by the additional data processing unit 131 to a VBI of the video frame transmitted to the converting unit 114.

The converting unit 114 converts the video frame to which the additional data is added into a digital signal in operation S112. The video frame converted into the digital signal is compressed by the compressing unit 115 using a specified compression codec in operation S113 and the compressed video frame is stored in the video storing unit 112 in operation S114.

A pattern of the additional data included in the VBI of the video frame converted into the digital signal is detected by the pattern detecting unit 111 in operation S115 and the detected pattern is stored in the memory unit 118 in operation S116.

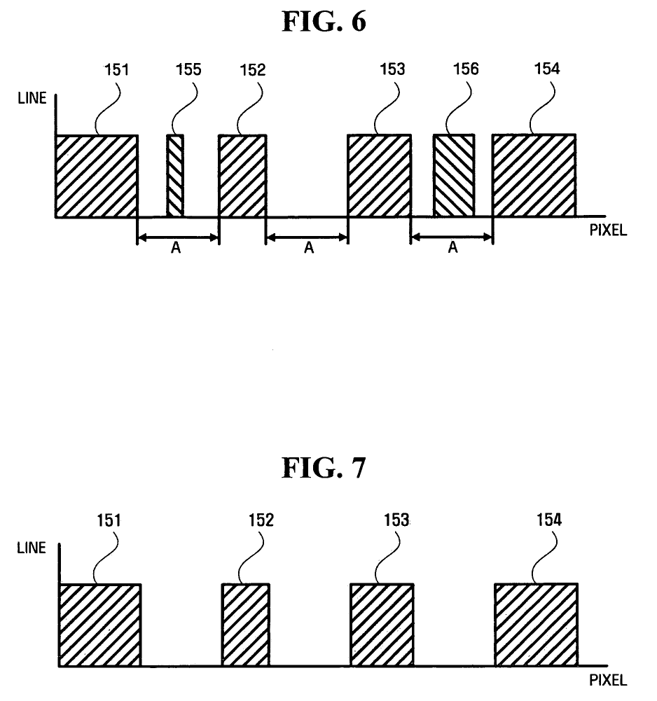

As shown in FIG. 6, the pattern of the additional data included in the VBI of the video frame converted into the digital signal may be detected using a section in which the additional data exists and a specified interval between additional data in a line in which additional data exist.

For example, if the specified interval between additional data is a pixel A, the pattern detecting unit 111 regards only additional data 151, 152, 153, and 154 that exist at intervals of the pixel A as being valid and regards other additional data 155 and 156 as noise and neglects the additional data 155 and 156. After removing the neglected additional data 155 and 156, as shown in FIG. 7, a pattern of only pixels corresponding to sections in which the valid additional data 151, 152, and 153, and 154 exist can be detected.

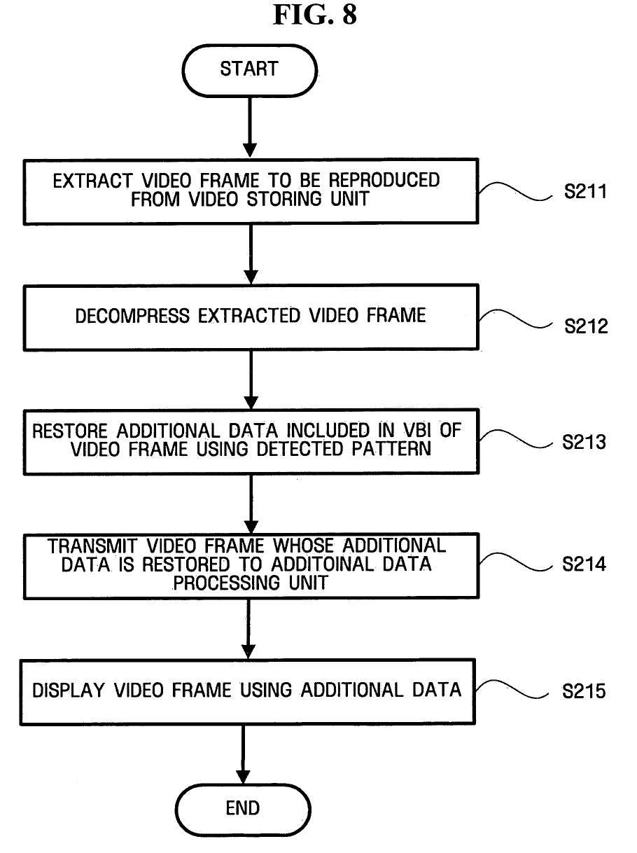

Referring to FIGS. 4 and 8, in a method for reproducing a video frame stored in the video storing unit 112 according to another embodiment of the present invention, a video frame to be reproduced by the reproducing unit 116 is extracted from the video storing unit 112 in operation S211.

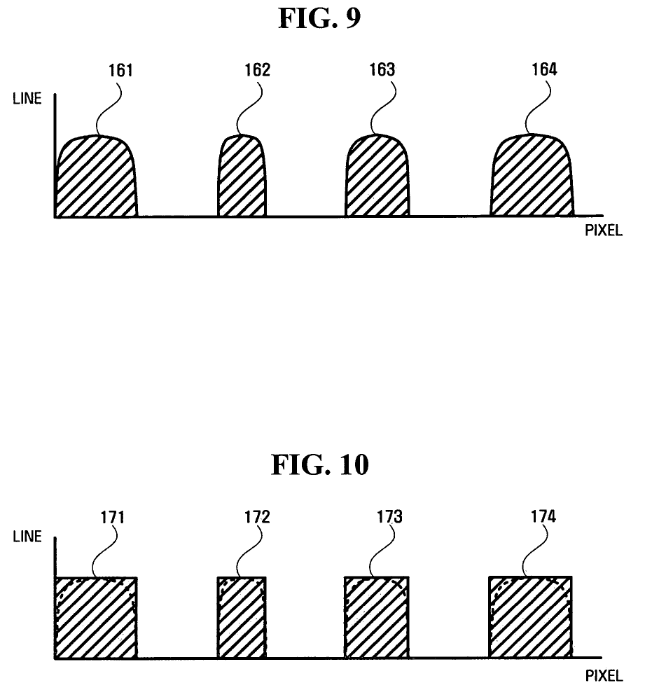

The extracted video frame is decompressed by the decompressing unit 117 in operation S212. At this time, as shown in FIG. 9, additional data 161, 162, 163, and 164 included in a VBI of the decompressed video frame have losses when compared to a pattern of additional data before it is compressed, since high-frequency areas, e.g., edges of a pattern, are removed when the video frame is compressed by the compressing unit 115. At this time, the pattern restoring unit 113 restores the losses in the decompressed video frame using the pattern stored in the memory unit 118 in operation S213.

Thus, as shown in FIG. 10, the losses occurring when compressing the video frame that is stored in the video storing unit 112 are restored to original additional data 171, 172, 173, and 174 by the pattern restoring unit 113 using the pattern stored in the memory unit 118. As shown in FIG. 9, the number of pixels in a section having decompressed additional data is compared to the number of pixels of additional data as shown in FIG. 7, and if the two numbers are the same, the decompressed additional data as shown in FIG. 9 is restored using the detected pattern as shown in FIG. 7.

Once the additional data is restored by the pattern restoring unit 113, the reproducing unit 116 transmits the decompressed video frame to the additional processing unit 131 in operation S214.

The additional data processing unit 131 displays the received video frame on the display unit 141 in various ways using additional data included in a VBI of the received video frame in operation S215. For example, when video frames are simultaneously acquired by the plurality of video acquiring units 161, 162, and 163, each video frame may include information about a corresponding video acquiring unit that acquires a corresponding video frame.

Thus, the additional data processing unit 131 may divide a screen of the display unit 141 into several sections and display the video frames acquired by the video acquiring units 161, 162, and 163 on the respective divided sections based on the information about the video acquiring units 161, 162, and 163.

The image processing device and method according to the above-described embodiments of the present invention detect a pattern of additional data included in a VBI of a video frame and restores lost additional data using the detected pattern, thereby easily restoring additional data when loss compression is performed to improve the efficiency in storing a video frame.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An image processing device comprising:
a pattern detecting unit which detects a pattern of additional data included in a vertical blank interval (VBI) of a video frame;
a video storing unit which stores the video frame; and
a pattern restoring unit which restores the additional data based on the detected pattern when the stored video frame is reproduced.

2. The image processing device of claim 1, further comprising:
a compressing unit which compresses the video frame stored in the video storing unit using a specified compression compressor/decompressor (codec); and
a memory unit which stores the detected pattern.

3. The image processing device of claim 2, wherein the pattern detecting unit detects the pattern based on the number of pixels in a section of a line in which the additional data is present.

4. The image processing device of claim 2, wherein the pattern detecting unit regards only additional data that is present at specified pixel intervals as a pattern.

5. The image processing device of claim 4, wherein the additional data includes information about a means for acquiring the video frame or time information about a time point at which the video frame is acquired.

6. An image processing method comprising:
detecting a pattern of additional data included in a vertical blank interval (VBI) of a specified video frame;
storing the specified video frame; and
restoring the additional data using the detected pattern when the stored video frame is reproduced.

7. The image processing method of claim 6, wherein the detecting of the pattern includes detecting the pattern based on the number of pixels in a section of a line in which the additional data is present.

8. The image processing method of claim 7, wherein the detecting of the pattern includes regarding only additional data that is present at specified pixel intervals as a pattern.

9. The image processing method of claim 8, wherein the storing of the specified video frame comprises storing the detected pattern and compressing the video frame using a specified compression compressor/decompressor (codec).

10. The image processing method of claim 9, wherein the additional data includes information about a means for acquiring the video frame or time information about a time point at which the video frame is acquired.

11. An image processing method, comprising:
adding additional information to a video frame;
detecting a pattern of the additional data;
compressing the video frame by removing a high frequency area of the additional data; and
decompressing the compressed video frame and restoring the additional information using the detected pattern.

12. The image processing method of claim 11, wherein the additional information is included in a vertical blank interval (VBI) of the video frame.

13. The image processing method of claim 11, wherein the additional information includes information about a video acquiring unit that acquires the video frame and time information about a time at which the video frame is acquired.

14. The image processing apparatus of claim 11, further comprising displaying the decompressed video frame with the additional data.

15. The image processing apparatus of claim 11, wherein the decompression includes comparing a number of pixels in a section of the video frame having decompressed additional data to a number of pixels of additional data and, when the two numbers are the same, the additional data is restored using the detected pattern.

16. The image processing method of claim 11, wherein the additional data is present at intervals of a number of pixels and the detecting includes detecting only data that is present at the intervals.

17. The image processing method of claim 11, further comprising displaying the decompressed video frame based on the additional data.

18. The image processing method of claim 11, further comprising:
storing the compressed video frame; and
extracting the stored video frame before the decompressing.

19. A method of increasing video frame storing efficiency, comprising:
detecting a pattern of additional data included in a video frame, the pattern being usable to restore the additional data when the video frame is reproduced from a storage;
compressing the video frame by removing a high frequency area of the additional data; and
storing the video frame in the storage.

20. A method of increasing video frame reproducing efficiency, comprising:
extracting a compressed stored video frame; and
decompressing the extracted video frame and restoring lost additional data to the video frame using a detected pattern of the additional data, the detected pattern being detected in the video frame before compression of the video frame.
